(19) United States
(12) Patent Application Publication
(10) Pub. No.: US 2002/0147814 A1
(43) Pub. Date: Oct. 10, 2002

(54) Multimedia devices over IP

(76) Inventors: Gur Kimchi, New York, NY (US); Omer Luzzatti, New York, NY (US)

Correspondence Address: KATTEN MUCHIN ZAVIS ROSENMAN, 575 MADISON AVENUE, NEW YORK, NY, 10022-2585, US

(21) Appl. No.: 09/826,656

(22) Filed: Apr. 5, 2001

(51) Int. Cl. G06F 15/173; G06F 15/16

(52) U.S. Cl. 709/226; 709/245; 709/204

(57) ABSTRACT

An architecture and method of providing minimal functionality multimedia devices having the capability of communication across networks, which provides a simple and low-MIPS platform to build computer-based devices. Minimal function devices such as video displays, keyboards, microphones, speakers and mice are connected across the network and associated in various configurations as terminal devices to perform the desired function. Terminal devices communicate over an IP network with a terminal server. The terminal server performs the necessary computing and implements the necessary protocols for the terminal devices, while the terminal devices implement minimum communications protocols to communicate their data with the terminal server. When the terminal device is connected to the IP-based network, the device announces its availability to the network and is discovered by the appropriate computing device. The terminal device then describes its capabilities to the computing device and is bound to a transport address. Once it is bound to the transport address, the terminal device is registered to a user. When a number of individual devices are registered, the devices are assembled into a virtual device and the appropriate applications and protocols are run on the computing device and associated with the terminal devices. The terminal device is a combination of a multimedia-input/output devices, or individual multimedia-input/output devices.

### BACKGROUND OF THE INVENTION

1. Field of Invention

The present invention relates generally to the field of multimedia devices. More specifically, the present invention is related to minimum functionality multimedia devices communicating over a packet-based network.

2. Discussion of Related Art

Most telephony services are currently provided over circuit-switched networks, known as Public Switched Telephone Networks (PSTN). This service is known as Plain Old Telephone Service (POTS). For a call using POTS service over the PSTN, a connection is reserved between the two users that does not allow any other users to use the connection. When the two users have completed the call, the call is disconnected and the line is free for other users again.

A new trend providing distinct advantages over POTS service on the PSTN is Internet telephony, also known as Voice-over-IP (VoIP) or IP telephony (IPtel). VoIP is telephony service provided over an IP-based network, ie. a packet switched network. Providing telephony service over an IP-based network allows packets carrying data for the call to be sent between two parties without reserving connections between the parties of the call. This is accomplished by digitizing the audio signals and encapsulating them into packets and sending them across the IP-based network. At the receiving side, the packets are decapsulated and the audio is played back. Because the data is carried digitally across the IP-based network, other media, such as video and shared applications, are also capable of being incorporated into a call without major changes. Due to this fact, the term VoIP, or Internet telephony is deemed to encompass the transmission of this other media, in addition to voice. Indeed, one of the advantages of IPtel is the transparency of the network to the media carried, allowing the addition of new media types with no change to the network infrastructure.

Another benefit of IP telephony is the integration of voice and data applications. Examples of such applications are integrated voice mail and e-mail, teleconferencing, computer-based collaborative work and intelligent call distribution. This integration of applications and telephony can result in significant increases in efficiency for businesses. In addition, new services can be enabled for both businesses and customers. Personal mobility, terminal mobility and multiparty conferencing are also supported by IPtel. IP telephony seeks to provide these advantages by moving the intelligence from the network to the terminal devices, such as computers and VoIP phones.

In addition to Internet telephony, there are other Internet multimedia services, such as broadcast and media-on-demand services. The distinguishing factor between these other services and IPtel is the need for signaling functionality with IPtel. A signaling function provides for the ability to create and manage calls. Currently, there are two standards available for performing IPtel signaling and control. One is the Session Initiation Protocol (SIP) proposed by the Internet Engineering Task Force (IETF) and is part of the IETF multimedia communications protocol suite. The other is part of the H.323 standard, which is the multimedia communications protocol suite proposed by the International Telecommunication Union (ITU). Both suites use generally the same protocols for media transport, and therefore, the main difference is the signaling and control protocols.

FIG. 1 illustrates these protocols, along with the other associated protocols for performing IP telephony, and more generally, for providing multimedia services and media transport over IP networks. The model for these protocols is a layered protocol, with every layer using the services of the lower layers and providing services to the higher layers. Data is encapsulated, from the top down, with each layer adding control information for handling the packet.

The physical and link layers are generally considered as a single split layer providing for the physical interface between a data transmission device and the transmission medium or network. The protocols illustrated at the physical and link layers are well known in the art, and will not be discussed further herein. It should also be noted, however, that generally, the Ethernet protocol is the more popular protocol implemented. It should also be noted that he protocols illustrated are not exhaustive of the possible protocols at this layer.

The IP protocol, denoted by IPv4 and IPv6, is a network layer protocol, which is part of the TCP/IP protocol suit, and is the most widely utilized internetworking protocol. This is a connectionless protocol, and, as such, there is no connection established between the endpoints of the communication. Data is transmitted as packets, with each packet at the IP layer considered as an independent unit of data. The IP protocol, and the network layer in general is primarily concerned with the exchange of data between an end system and the network to which it is attached and the routing of packets across networks.

The Transmission Control Protocol (TCP) is a connection-oriented transport layer protocol. TCP is responsible for dividing the message into packets, which IP handles and for reassembling the packets back into a complete message. The User Datagram Protocol (UDP) is a connectionless transport layer protocol. UDP is similar to TCP except that UDP does not provide sequencing of packets that the data arrives in. Therefore, higher-level protocols must be capable of ensuring that the entire message has arrived and capable of ordering the packets when UDP is used. These protocols are generally concerned with the host-to-host exchange of data.

The foregoing protocols are those that are typically used for internetworking generally. The other protocols illustrated have been developed specifically for providing multimedia services and IPtel services across the Internet, internetworks, or networks in general. Some of the protocols require the use of TCP/UDP while others are open as to the underlying protocols.

The Real-time Transport Protocol (RTP) is a protocol for real-time data, such as audio and video. This protocol is utilized for general multimedia services, in addition to the transport of IP telephony data. This protocol consists of a data part and a control part. The data part of RTP provides support for real-time properties such as timing reconstruction, loss detection, security, and content identification. The control part of RTP, known as the Real-time Control Protocol (RTCP) provides support for services such as source identification, quality of service feedback, as well as support for the synchronization of different media streams.

The Resource Reservation Protocol (RSVP) is a protocol that allows channels on the Internet to be reserved for the transmission of multimedia, such as video and other high bandwidth data. Using RSVP, bandwidth can be reserved on the Internet to support this high bandwidth data, rather than relying upon the Internet's basic routing philosophy of “best effort,” which is generally inadequate for continuous streaming of video or audio programs.

The Real Time Streaming Protocol (RTSP) is an application-level protocol to control the delivery of data with real-time properties. This protocol is intended to control multiple data delivery sessions, provide a means for choosing delivery channels, and provide a means for choosing delivery mechanism based upon RTP.

As previously described, H.323 is a standard which provides for IP telephony signaling. While the H.323 standard provides recommendations for signaling, H.323 is an umbrella recommendation for providing multimedia communications over networks that do not provide Quality of Service (QoS). H.323 actually comprises several protocols used for different purposes but that work together. H.323 provides recommendations for compliant terminal units to utilize these protocols and defines four major components for a network-based communication system.

FIG. 2a illustrates an H.323 network-based communication system. The four major components for network-based communication defined by H.323 are terminals 200, 202, 204; gateways (not shown); gatekeepers 206 and multipoint control units (not shown). Terminals are client endpoints on the packet switched network that provide real-time, two way communications with other H.323 entities. H.323 terminals are required to support three functional parts: signaling and control, real-time communication, and codecs.

The terminal equipment supporting these functions is illustrated in FIG. 2b. For signaling and control 212, H.323 terminals must support the H.245 protocol 214, which is a standard for channel usage and capabilities, in addition to a Q.931-like protocol 216 defined in H.225.0 for call signaling and establishment. The terminal also supports a Registration/Administration/Status protocol 218 defined in H.225.0 for communication with gatekeepers 206. These protocols use ASN.1 encoding for their messages. For real time communication, H.323 terminals must support RTP/RTCP 226 for the sequencing of audio and video packets. Codecs 222, 224 are pieces of software that compress audio/video before transmission and decompress received audio/video. In order to maintain interoperability, H.323 terminals are required to support the G.711 audio codec. Video and other audio codecs are optional, however, if used must support a specified common mode of operation. In addition, H.323 terminals can support general data communications, using T.120. While outside of the scope of the recommendation, a H.323 terminal should support a LAN (network) interface.

While not shown, gateways in a H.323 network provide the same general services as gateways in other networks. Specifically, an H.323 gateway provides the connection between the packet-switched network and a Switch Circuit Network, such as the PSTN. Gateways perform setup and control on both the packet-switched network and the Switch Circuit Network, and act as an interface between the two to translate between transmission formats and procedures.

Also not shown are multipoint control units (MCU). MCUs support conferencing between three or more endpoints. The MCU provides control functions such as negotiation between terminals and determination of common capabilities for processing audio and video, in addition to the necessary processing on the media streams.

Gatekeepers 206 perform four required functions. The first of these is address translation from alias addresses or phone numbers to transport addresses. This provides the capability of terminal mobility. In addition, gatekeepers 206 provide support for admission control, bandwidth control and zone management. When a gatekeeper 206 is present, all other endpoints are required to register with gatekeeper 206 and receive its permission prior to making a call.

H.323 uses the concept of channels to structure the information exchange between communication entities. A channel is a transport-layer connection, which is either unidirectional or bi-directional. The H.323 standard defines four types of channels: RAS Channel, Call Signal Channel, H.245 Control Channel and Logic Channel for Media. The RAS Channel provides a means for communication between an endpoint and its gatekeeper. As previously described, this protocol is specified in H.225.0. Through the RAS Channel, an endpoint registers with its gatekeeper along with requesting permission to place a call to another endpoint. If permission is granted, the gatekeeper 206 returns the transport address for the call signal channel of the desired endpoint.

The call signal channel carries information for call control. The Q931-like protocol used for this channel is defined in H.225.0 and H.450.x. The H.245 Control Channel carries messages for media control with capability exchange support. The H.245 Control Channel is used for all call participants to exchange their capabilities, after which, Logical Channels for Media are opened through the H.245 Control Channel. Logical Channels for Media carry the audio, video and other data. Each media type is carried on a separate channel using RTP.

H.323 also provides for an inter-gatekeeper communication protocol for gatekeepers 206 in order to support terminal mobility when utilized in conjunction with the registration function. This means that a terminal device is capable of being moved from one network point to another, therefore acquiring a different transport address, however, a call can still be established using the higher abstract level alias address (E. 164 or H3231D) or phone number. With the use of the registration services of the gatekeepers 206, the terminal device registers its transport address and alias address or telephone number so that its gatekeeper can perform the address translation. Through the use of the inter-gatekeeper communication protocol, when one endpoint seeks to establish a call with another endpoint using the alias address or phone number, an address can be located for an endpoint registered in a different zone or administrative domain.

Referring to FIG. 2a, terminal device 200 registers itself with its gatekeeper 206 and receives permission to make a call from gatekeeper 206 utilizing the RAS Channel. When the client receives permission and begins to make a connection, the alias of the called terminal device 204 is provided to gatekeeper 206. Terminal device 204 is located in a different domain, having its own gatekeeper (not shown) to which it is registered. Using its inter-gatekeeper communication protocol, gatekeeper 206 locates terminal device 204 and returns the endpoint's 204 transport address to terminal device 200, which then uses its Call Signal Channel, H.245 Control Channel and Logical Channel for Media to establish and conduct the call when in direct call mode. Alternatively, in a gatekeeper routed mode, instead of returning the transport address of terminal device 204, gatekeeper 206 instead routes the SETUP message to terminal device 204. Support is also being considered in the H.323 standard for personal mobility, i.e. the ability to reach a called party under a single, location-independent address even when the user changes terminals.

As previously mentioned, another multimedia communications protocol suite has been proposed by the IETF. In the IETF architecture, the media flows are performed utilizing RTP, as in H.323, and therefore, as previously described, the main difference is the signaling and control protocol. The SIP protocol is utilized in the IETF architecture for call signaling and control. SIP is an application layer protocol that can establish, modify and terminate multimedia sessions or calls.

FIG. 3a illustrates a SIP based communications network. The components for a SIP based network communication system are similar to those of H.323. These are terminal devices 300, 302, 304; proxy/redirectors 306; and registrars 308. As with H.323, terminals are client endpoints on the packet switched network that provide real-time, two way communications with other SIP entities.

FIG. 3b illustrates a typical SIP terminal device (endpoint). For performing system control/signaling a SIP endpoint comprises a user agent (UA) 312. The user agent comprises a user agent client (UAC) 314 and a user agent server (LAS) 316. UAC 314 is responsible for issuing SIP requests, and UAS 316 is responsible for responding to such requests. The rest of the terminal device supports similar capabilities as a H.323 terminal.

The proxy/redirectors 306 and registrar are known as network servers. Roughly these servers are analogous to a H.323 gatekeeper, while UA 312 is equivalent to the set of H.323 terminal system control protocols.

A typical SIP operation involves a SIP UAC issuing a request, a SIP server performing end user location and a SIP UAS accepting the call. SIP session establishment consists of two requests: an INVITE followed by an ACK. The INVITE message contains session description information that informs the called party what type of media the caller can accept and where it wishes the media data sent, while the ACK confirms session establishment.

Referring to FIG. 3a, when terminal device 300 wants to establish a call with terminal device 304, it sends an INVITE message to proxy/redirector 306 using UA 316. SIP user agents need to determine whether to use an outbound proxy and where to send registration updates. The address of the outbound proxy can be configured manually and the registration can be sent via multicast. DHCP is an additional method for configuring this information. DHCP is used extensively to configure boot-time information in IP-connected hosts. For more sophisticated selection of proxies, the IETF Server Location Protocol (SLP) allows proxies and registrars to advertise their capabilities. In large networks, users may have a choice about the SIP server they connect to. Different servers can provide different services to their users; for example, some may support CPL execution, and others may not. Some may support IPSec, and some may not. SLP, specified in RFC 2608, defines a way in which SIP end systems can discover SIP servers providing specific capabilities.

In any case, when proxy/redirector 306 receives the INVITE message, it communicates with a registrar/location server 308 to retrieve the location (transport address) corresponding to the SIP-URL used to indicate the callee. Typically, registration is performed by a terminal device upon startup utilizing a REGISTER message. When acting as a proxy, server 306 establishes the call by sending an INVITE to terminal device 304 and continues to act as a go-between for the endpoints during the session. When acting as a redirector, server 306 returns the address of terminal device 304 to terminal device 300, which then establishes the session directly with terminal device 304. It should be noted that, while illustrated as two different machines, often times registrar 308 and proxy/redirector 306 are implemented on the same machine. Also, through the use of the registration server, SIP provides for terminal mobility, in addition to personal mobility.

The session multimedia description information within a SIP request and response message, as well as announcements for a session are provided for using the IETF Session Description Protocol (SDP) 318. This protocol is generally the equivalent of H.245 in the H.323 standard.

The Media Gateway Control Protocol, developed by Telcordia and Level 3 Communications, is one of a few proposed control and signal standards to compete with the older H.323 standard for the conversion of audio signals carried on telephone circuits (PSTN ) to data packets carried over the Internet or other packet networks. The reason new standards are being developed is because of the growing popularity of Voice over IP (VoIP ). MGCP and Megaco/H.248 are media gateway control protocols defined by the IETF and ITU-T for use in distributed switching environments. Referring to FIG. 3c, signaling logic is located on Media Gateway Controllers 330 (MGCs—also known as Call Agents or SoftSwitches) and media logic is located on Media Gateways 332 (MGs). Using MGCP or Megaco/H.248 334, MGCs can control MGs to set up media (for example, voice traffic) paths 336 through the distributed network. Regular phones are relatively inexpensive because they don't need to be complex; they are fixed to a specific switch at a central switching location. IP phones and devices, on the other hand, are not fixed to a specific switch, so they must contain processors that enable them to function and be intelligent on their own, independent from a central switching location. This makes the terminal (phone or device) more complex, and therefore, more expensive. The MGCP is meant to simplify standards for this new technology by eliminating the need for complex, processor-intense IP telephony devices, thus simplifying and lowering the cost of these terminals.

The above described protocols for multimedia transport and VoIP are integrated into personal computers using input/output devices connected thereto utilizing standard serial or parallel connections, or fully implemented in standalone devices, such as VoIP telephones or VoIP videophones. This is disadvantageous as it creates complex terminal devices, adding to the costs of these devices, or software used to implement these services. The present invention provides for an architecture and method of performing VoIP, which simplifies the terminal devices used for communication, allowing terminal devices having minimal functionality. The present invention also provides for other advantages as will be obvious to one of skill in the art from the following detailed description.

The following references describe other IP telephony systems or packet based communication systems:

The patent to Rondeau et al. (5,796,728), assigned to Ericsson Inc., provides for a Communication System and Method for Modifying a Remote Radio Using an Internet Address. The patent describes a two-way multi-user radio communication system. Additional devices attached to the radio include GPS-based automatic vehicle locator, mobile data terminal (e.g., bar code reader), printer and/or a video apparatus. Each of the devices is assigned a different IP address and can independently, but not simultaneously, send/receive data packets to/from the host computer. However, the host computer does not perform any processing to establish calls between radio units and other end devices. In addition, as previously described, it is not contemplated by Rondeau that the attached devices could transmit data simultaneously and therefore it is not contemplated to allow the devices to act as general, simultaneous input/output devices for control of the host computer.

The patent to Mashinsky (6,005,926) assigned to ANIP, Inc., provides for a Method and System for Global Communications Network Management. The patent teaches a system and method for flexible and efficient routing of communications transmissions. It further states that a global network may embrace all classes of connectivity, including VoIP networks.

The patent to Arango et al. (WO 99/28827) provides for a Method and System for Media Connectivity over a Packet-based Network. The patent discloses a method and system for a distributed, scalable, hardware independent system that supports communication over a packet-Page based network. The communications include VoIP, video conferencing, data transfer, telephony, and downloading video or other data. The media control devices uses Real Time Protocol (RTP) to communicate over an IP network. A central call agent that translates from a fully implemented protocol in a terminal device, such as H.323, to a second filly implemented protocol, provides the hardware independence.

The patent to Lee et al. (EP 0 964 567) provides for a Programmable Telecommunications Interface for Communication over a Data Network. The patent describes a multimedia communications protocol for multimedia applications such as video conferencing, Internet telephony, and VoIP.

Whatever the precise merits, features and advantages of the above cited references, none of them achieve or fulfills the purposes of the present invention.

### SUMMARY OF THE INVENTION

A system and method of connecting terminal devices, whether a combination of input/output devices co-located communicating with a single transport address, or an individual input/output device communicating with a transport address, to a server computer, personal computer or other computing device. When the terminal device is connected to the IP-based network, the device announces its availability to the network and is discovered by the appropriate computing device. The terminal device then describes its capabilities to the computing device and is bound to a transport address. Once it is bound to the transport address, the terminal device is registered to a user. When a number of individual devices are registered, the devices are assembled into a virtual device and the appropriate applications and protocols are run on the computing device and associated with the terminal devices. When the connected device(s) are utilized for IPtel, the computing device additionally registers the endpoint, running on the computing device and associated with the connected device(s), on the IPtel communications network.

A first embodiment of the present invention comprises a terminal server and one or more connected terminal devices. The terminal server is connected on one side to an IPtel network and implements the appropriate protocols for communication across the IPtel communications network for each connected terminal device. The terminal device is a combination of a microphone, speaker, video capture device, video playback device, text entry device, text display or co-ordinates control device and implements the minimum protocols for communications of data from the combination of input/output devices to the terminal server over an IP-based network.

In the second embodiment of the present invention, each of the individual input/output devices are capable of communicating their data using minimum protocol to the terminal server over an IP-based network. When devices are connected to the network, they are grouped together into a virtual device by the terminal server, with the terminal server performing the appropriate processing and implementing the appropriate protocols to emulate the virtual device.

The third embodiment of the present invention provides for the individual input/output devices to be connected to a personal computer or other computer-based device utilizing an IP-based network. This allows for the user interface to be dislocated from the actual computer processing.

In one embodiment, an association of minimal functionality VoIP multimedia devices provides the capability of communication across VoIP networks. A simple and low-MIPS platform is used to build VoIP based communications that support both one-way and interactive text, voice and video. The present invention also provides additional advantages by enabling multiple services and allowing input/output manufacturers to expose their equipment over an IP network.

### BRIEF DESCRIPTION OF THE DRAWINGS

FIG. 1 illustrates the protocols for transmitting multimedia and performing IP telephony across an IP-based network.

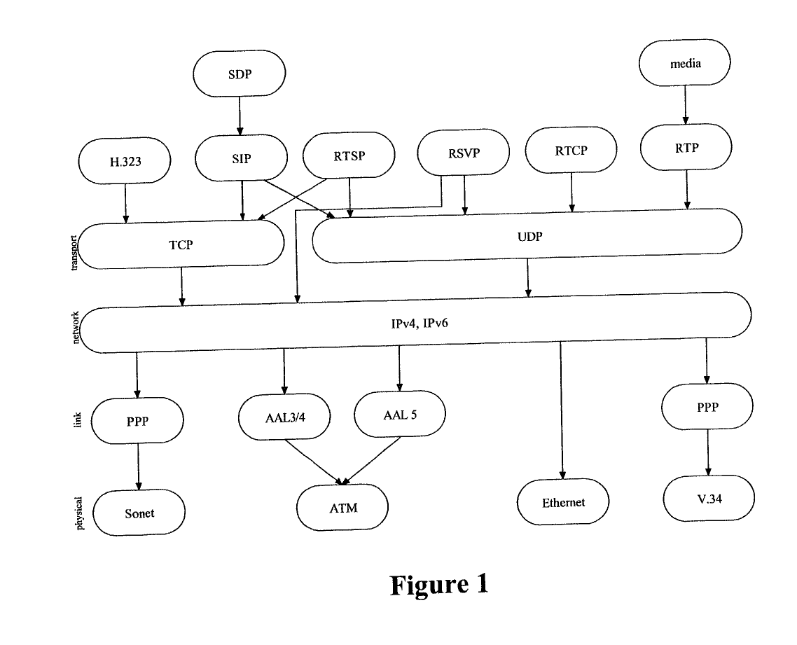

FIG. 2a illustrates an H.323 network-based communication system.

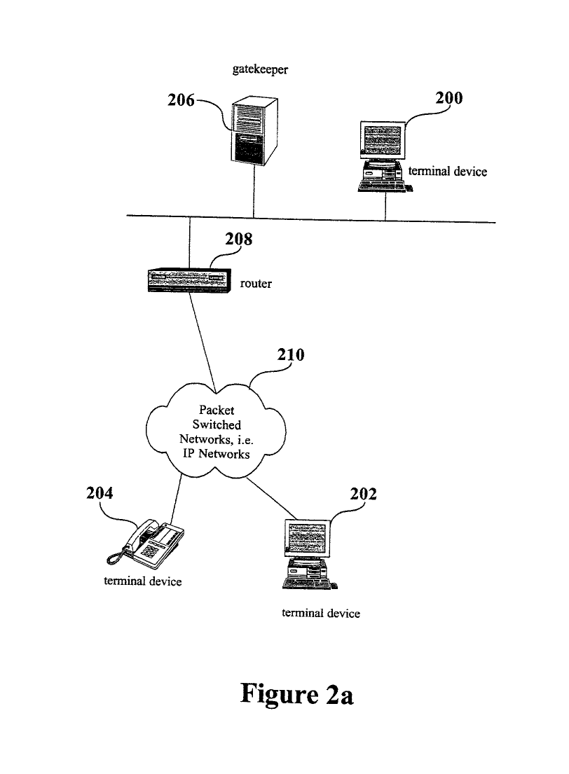

FIG. 2b illustrates a typical terminal device for a H.323 network.

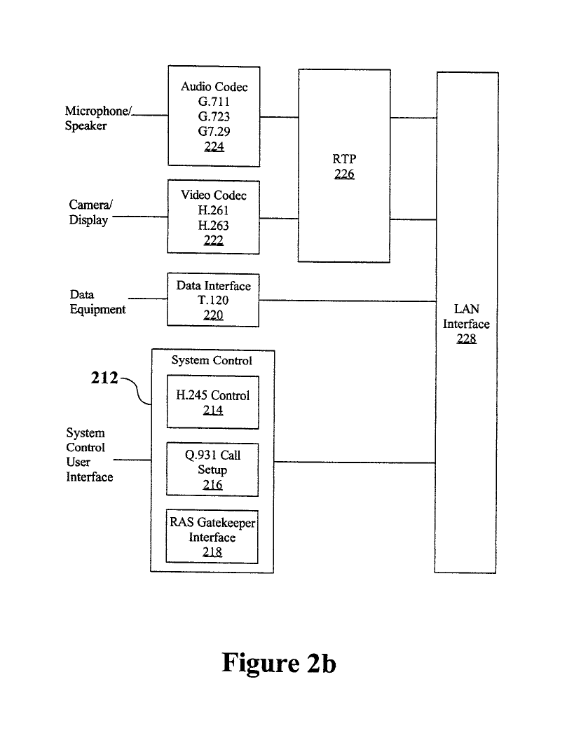

FIG. 3a illustrates a SIP based communications network.

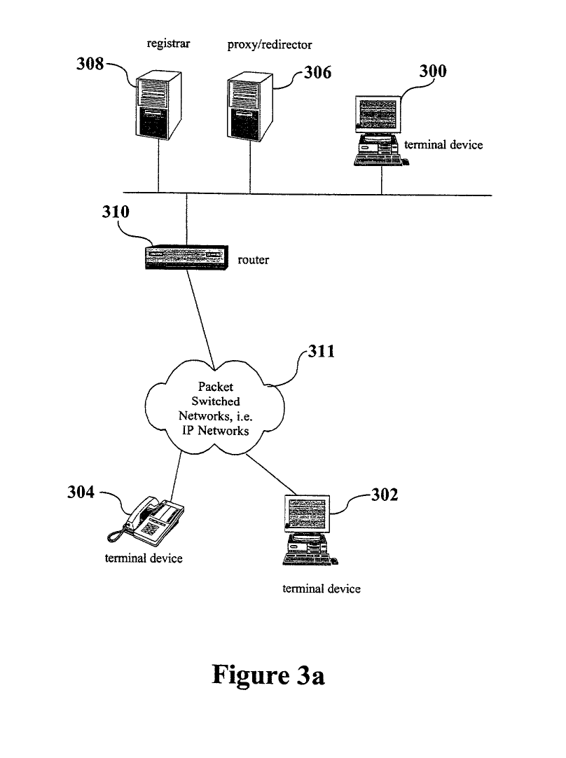

FIG. 3b illustrates a typical terminal device for a SIP network.

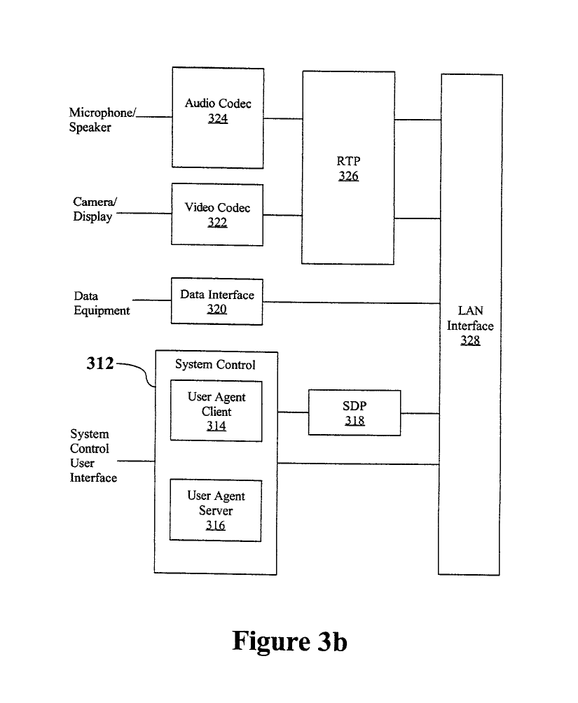

FIG. 3c illustrates a MGCP or H.248/Megaco based communications network.

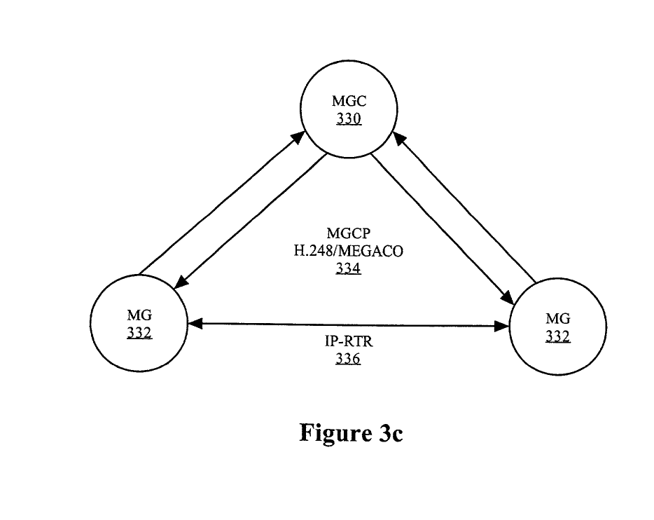

FIG. 4 illustrates the general architecture of the present invention.

FIG. 5 illustrates a security system built using IP-based video capture devices.

FIG. 6 illustrates a video on demand system built using IP-based video displays.

FIG. 7 illustrates a second embodiment of the present invention.

FIG. 8 illustrates the general method of the present invention.

FIG. 9 illustrates the general architecture of the present invention.

FIG. 10 illustrates the use of the present invention to provide a simple corporate VoIP system via the corporate intra-net utilizing minimum functionality VoIP phones.

FIG. 11 illustrates the present invention utilized to implement residential telephone services.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. Throughout the specification various known VoIP communication protocols are cited such as H.323 or SIP. However, MGCP or Megaco/H.248 or other known or future protocols for VoIP may be substituted therefore.

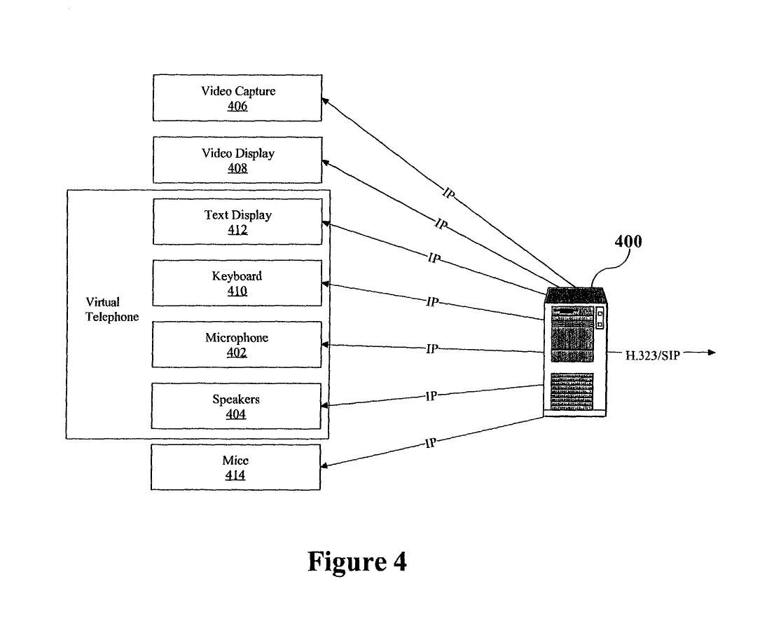

FIG. 4 illustrates a general architecture of the present invention. A plurality of minimal functional devices 406-414 are operationally connected to terminal server 400. Minimal functional lain refers to a single function or, in alterative embodiments, base functions comprised of simple combinations of single functions. In this embodiment, each input/output device is independently capable of communicating across a packet switched network, i.e. IP network. Therefore, the following devices are individually capable of communicating with the terminal server 400 utilizing their corresponding communication protocols:

Audio-over-RTP/IP Microphone 402

Audio-over-RTP/IP Speaker 404

Video-over-RTP/IP Video Capture 406

Video-over-RTP/IP Video Playback 408

UTF8-over-RTP/IP Keyboard 410

UTF8-over-RTP/IP Text Display 412

Co-ordinates-over-IP Tracking Device (e.g. mouse) 414

Each individual device is given the capability of communicating and transmitting its respective data across the network. Thus, the present invention provides for the capability of dynamically creating “virtual” devices from the individual input/output components, with all of the appropriate protocols for communication and applications running on terminal server 400.

For instance, a user connects microphone 402, speaker 404, keyboard 410 and text display 412 to the IP network. The devices announce their availability across the network as described above. When terminal server 400 discovers the devices on the network and learns of their capabilities, each device is bound to a transport address. Registration of the devices to a person is performed and, preferably, secure communications is implemented utilizing IPsec. The type of virtual device the individual devices are to emulate is then transmitted to terminal server 400. In the present example, the association of devices 402, 404, 410 and 412 is utilized as a virtual phone. Terminal server 400 then implements the virtual phone by creating a H.323/SIP endpoint associated with the group of devices, and performs the registration functions associated with H.323/SIP in order to register the alias address/SIP URL of the associated endpoint, allowing the individual devices to act as a virtual phone. Terminal server 400 then transmits the appropriate data and receives the data from each individual device via the devices transport address across the IP-based network for any initiated sessions.

As previously mentioned, the present invention allows for any device to be emulated by implementing the appropriate protocols and applications in terminal server 400 once the devices are located (discovered) by terminal server 400, bound, registered and the type of device to be emulated is indicated. In addition, the present invention allows the capabilities of an emulated device to be easily changed. For instance, in the present example, if the user additionally connects a video playback device 408 to the network, after discovery, binding and registration, if it is indicated that video playback device 408 is to be part of the virtual VoIP phone, then terminal server implements the appropriate protocols in the endpoint associated with the virtual phone to support video services. Thus, video capability is added to the virtual VoIP phone, essentially allowing it to become a virtual VoIP videophone.

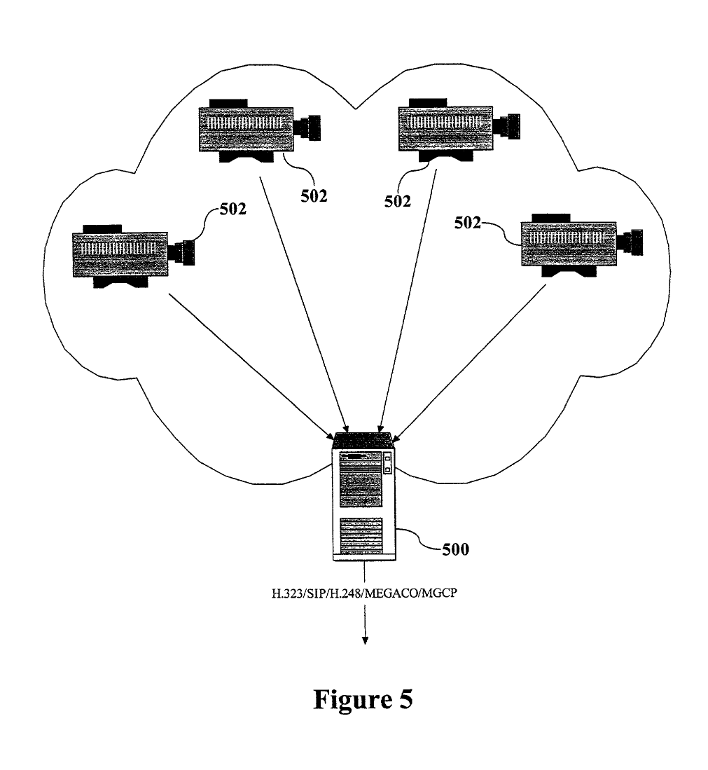

Utilizing IP-based networks for the communication of input/output devices and a server to create virtual devices allows for a number of easily deployable systems. For instance, as illustrated in FIG. 5, a security system is built using video capture devices 502. These devices transmit their video information to a server 500 utilizing video-over-RTP/IP. Because these devices use IP-based communications, the security system is able to be deployed using a corporate network already in place, without deploying new video cabling. Server 500 implements all appropriate applications, and when communications is desired to received the video transmission at a station different from server 500, server 500 also implements the appropriate communications protocols such as H.323 or SIP in order to transmit the video across networks to an end station.

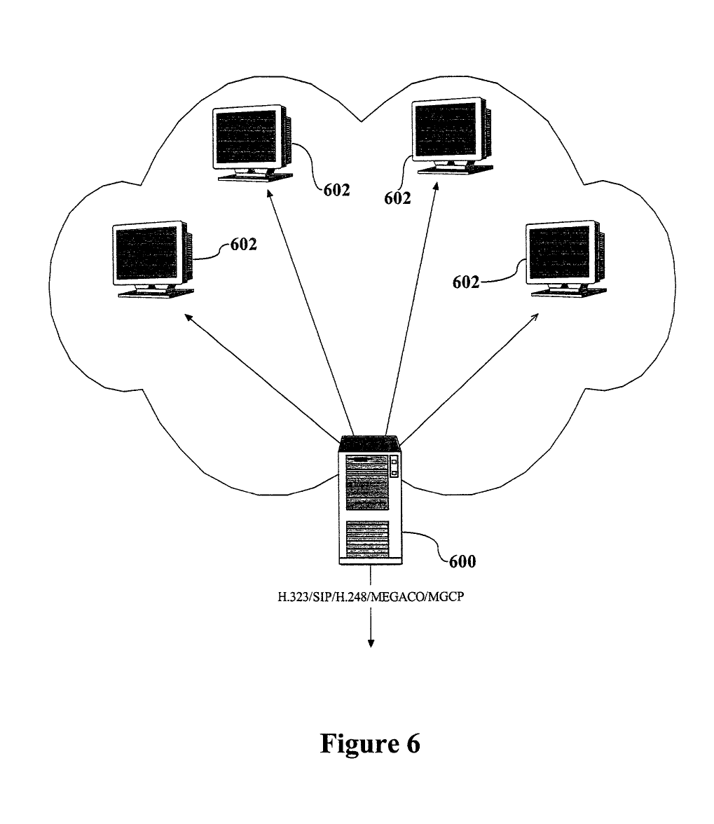

Likewise, FIG. 6 illustrates a video on demand system built from video playback devices 602 communicating with server 600 utilizing video-over-RTP/IP. Server 600 implements the appropriate applications to act as a video server.

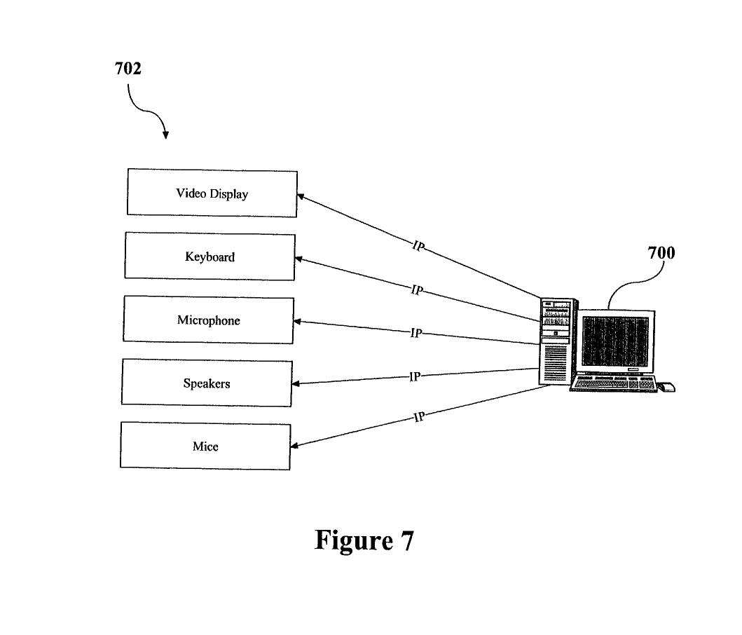

FIG. 7 illustrates a second embodiment of the present invention. Like the first embodiment, individual input/output devices 702 are capable of communicating their respective data across an IP-based network. In the second embodiment, the individual input/output devices 702 communicate with a computer 700, acting as the input/output devices controlling computer 700. This allows for processing to be dislocated from the input/output devices themselves, providing for the capability of creating a “virtual” computer from the individual devices 702, dislocated from the actual processing. A number of individual input/output devices 702 are connected to the IP-based network and communicate with computer 700, which runs applications and performs normal processing associated with a computer. One advantage provided is the ability for a “virtual” laptop to be built from the basic input/output components, which is capable of being smaller in size and having lower power requirements than currently capable.

While it is deemed within the spirit of the present invention for a single computer to provide the processing capability and applications for a single set of devices, it is particularly advantageous to have computer 700 support the processing for multiple sets of devices, allowing multiple virtual computers to be emulated. In addition, by allowing each device the capability of communicating across the IP-based network, new input/output devices can easily be added to the virtual computer.

As with the first embodiment, when devices are connected to the IP-based network, they announce their presence and are discovered by computer 700 and bound to a transport address. The devices are then registered to a user and an indication that they are to emulate a virtual computer is sent.

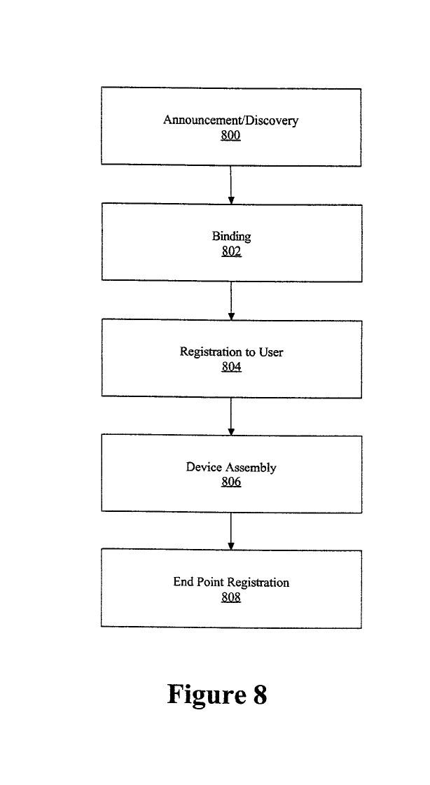

FIG. 8 illustrates the general method of the present invention. The first step of the method is device discovery 800. Each device announces its presence on the network when connected to the network. This is performed using an appropriate protocol such as H.323, SIP, IETF SLP, or DNS, preferably using multicast to add to the simplicity of discovery. In addition to terminal discovery, the devices provide a description of their capabilities to the terminal server using a protocol such as SDP, H.245, HTML, XML, IETF ConnNeg or any proprietary means. Once a terminal server is located, the device is bound to a transport address 802. Registration of the devices to a person is performed and, preferably, secure communications is implemented utilizing IPsec 804. When the devices are individual input/output devices, the type of virtual device the individual devices are to emulate is then transmitted to terminal server 806 and the server implements the appropriate processing. When the server provides IPtel services, it registers the endpoint associated with the device on the H.323/SIP network 808.

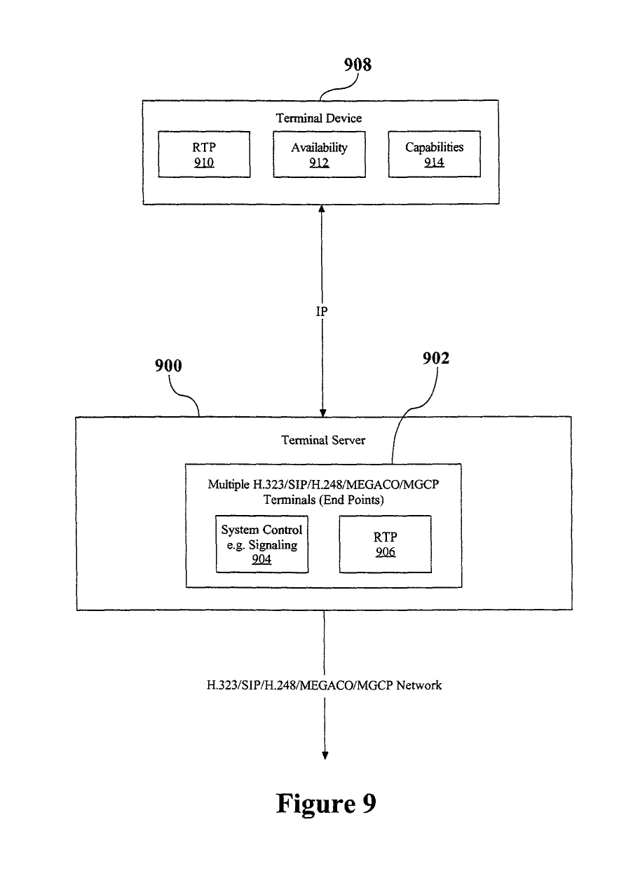

FIG. 9 illustrates the general architecture of the present invention. As illustrated, the present invention comprises a terminal server 900 and terminal device 908. Terminal server 900 exposes a H.323/SIP 902 endpoint interface on one side, and a terminal device 908 on the other. Preferably, terminal server supports multiple H.323/SIP terminals (endpoints) and receives multiple terminal devices.

Terminal server 900 provides H.323/SIP terminals by implementing the functionality 904, 906 on one side to communicate across a H.323/SIP network. This functionality is implemented as H.225.0, H.450.x, H.245, RTP 906 and any other necessary protocol defined by the standard for control, signaling and media and data transport when connected to a H.323 network. For connection to an SIP network, terminal server implements a UAC, UAS, SDP, RTP 906 and any other protocols or functionality defined or utilized with SIP. Terminal server 900 performs all processing and communications required to utilize the connected H.323/SIP network.

It should be noted that the terminal server's functionality may be implemented on more than one machine, or multiple servers may be utilized so as to provide scalability and load balancing.

On the other side, terminal server 900 communicates with terminal device 908 via an IP based network. Terminal device 908 is any device that is a combination of a microphone, speaker, video capture device, video playback device, text entry device, text display device or coordinates control device (e.g. mouse). An exemplary terminal device is a VoIP telephone, which is a combination of a text display device, text entry device, microphone and speaker. Terminal device 908 has a single IP address utilized for communications with terminal server 900.

Terminal device 908 is associated with a particular H.323/SIP terminal/endpoint implemented by terminal server 902. When a call is made utilizing terminal device 908, terminal server 900 performs the processing for communications across the H.323/SIP network. Because terminal server 900 performs the processing for communications across H.323/SIP network, this functionality does not need to be implemented in terminal device 908, rather terminal device 908 must only be able to transmit its data, announce its availability, describe its capabilities to terminal server 900 and have the ability to output received data. This allows for simplified terminal devices.

The present invention additionally simplifies the terminal devices by allowing all integrated VoIP applications to be run on terminal server 900. For instance, an integrated voice mail and email application can be run on terminal server 900, with the output of the application provided to the terminal device 908 for display to the user via the IP-based network. Also, input to the application is transmitted from terminal device 908 to terminal server 900 for processing.

Preferably, the protocol that terminal device 908 utilizes to transmit its data is RTP over a TCP/IP based network. Therefore, terminal device 908 supports RTP 910. While any physical/link layer protocols are capable of being used, such as Ethernet, the preferred embodiment envisions that the underlying communications medium is wireless, and therefore any appropriate physical/link layer wireless protocols are also within the spirit of the present invention.

As an example, when terminal device 908 is a VoIP telephone, when a call is to be made, a caller dials the number of the callee. This information is transmitted to terminal server 900 using UTF-8-over-RTP/IP. Terminal server 900 receives this information and utilizes H.323/SIP endpoint 902 associated with terminal device 908 to perform call establishment. To the H.323 /SIP network, terminal server 900 looks like terminal device 908. Once the call is established, terminal server 900 receives voice data from callee and transmits it to terminal device 908. Terminal device 908 outputs the voice via its speaker. Terminal device 908 receives voice signals via its microphone and transmits them using Audio-over-RTP/IP to terminal server 900. Terminal server 900 utilizes H.323/SIP endpoint associated with terminal device 908 and transmits the data to the callee.

As previously described, it is desirable for terminal device 908 to announce its availability when connected to the network so as to establish a connection with terminal server 900 in order to transmit the appropriate data between terminal device 908 and terminal server 900. The protocol to support this functionality can be any appropriate protocol such as a proprietary protocol, the IETF SLP protocol, H.323, SIP, DNS or RTP/RTCP application packets. It is preferable to utilize multicast transmission to make discovery of terminal device 908 by terminal server 900 simple. In addition, it is preferable that terminal device 908 be capable of informing the terminal server 900 it is no longer available for services upon its power down physical disconnection.

In addition, it is also preferable for terminal device 908 to describe its capabilities, such as voice or video capability and what type of format for a given capability. The protocol supporting this function can be any appropriate protocol such as a proprietary protocol, SDP, H.245, HTM, XML, or IETF ConnNeg. Also, it is preferable that the devices be capable of performing secure transmissions utilizing a security protocol such as IPsec.

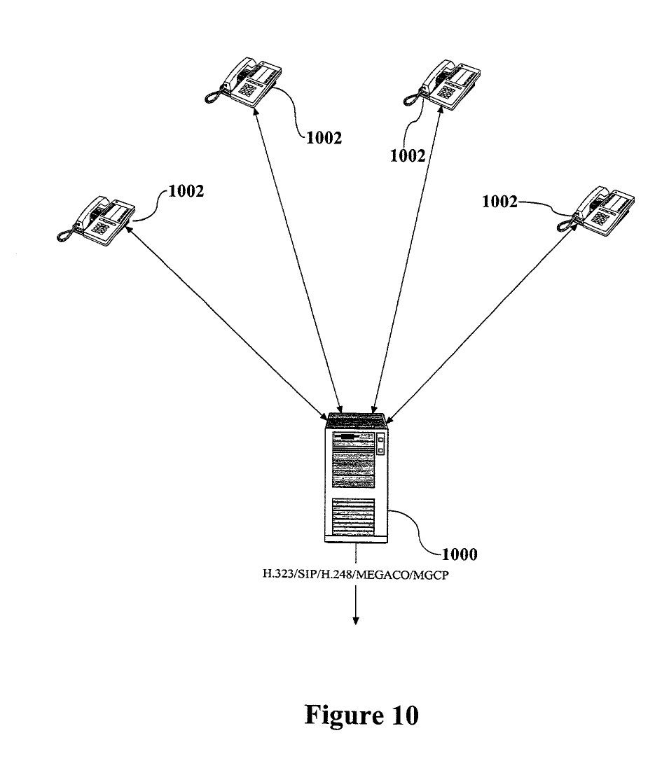

FIG. 10 illustrates the use of the present invention to provide a simple corporate VoIP system via the corporate intranet utilizing minimum functionality VoIP phones. Phones 1002 have the architecture of terminal device 908 as illustrated in FIG. 9 and connect to a terminal server 1000 over a corporate IP/Ethernet intra-net. Under normal circumstances, a single segment 10base-T Ethernet network can support more than 75 simultaneous VoIP phones when using just audio (assuming G.711, silence compression at 50%, generating 128 Kbit/sec per bi-directional audio stream). Assuming 10% of these devices are handling calls at the same time, this allows deployment of 750 minimal functionality VoIP telephones on a single non-switched 10 megabit Ethernet segment.

An additional advantage of the present invention allows for the implementation of new IPtel standards, or the additions of new functionality as the H.323 and SIP standards mature by upgrading the terminal server functionality, without the need to upgrade terminal devices, additionally decreasing costs. This is particularly advantageous when large-scale IPtel systems, such as the corporate intra-net are deployed, or when the present invention is utilized to provide residential telephone services.

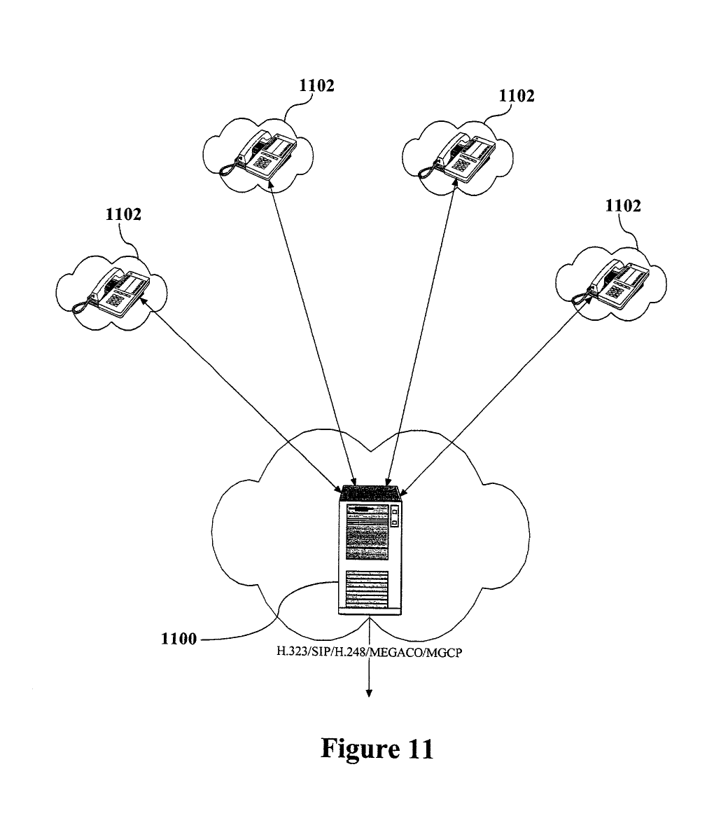

FIG. 11 illustrates the present invention utilized to implement residential telephone services. Simple and inexpensive minimal functionality terminal devices 1102, i.e. audio or multimedia devices are placed at the subscriber's premises. The residential LAN is connected using IP access links to the main LAN that contains terminal server 1100.

### CONCLUSION

A system and method has been shown in the above embodiments for the effective implementation of multimedia devices over IP. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware or specific multimedia transmission protocols. Existing and future input/output devices are envisioned within the scope of the present invention,

1. A computer-based system of building virtual network devices, said network devices connected to one or more servers across network communication mediums, said system comprising:
a first function device;
a second function device;
a remote terminal server, said remote terminal server operatively connected to at least said first and second function devices;
a processing function within said terminal, said processing function including a session which includes discovery, association and registration of at least said first and second function devices, and
said processing function emulating an equivalent network device based on the combined capabilities of said first and second function devices, their inputs/outputs sent and received during said session, and applications of said equivalent network device.

2. A computer-based system of building virtual network devices, as per claim 1, wherein said system comprises two or more function devices.

3. A computer-based system of building virtual network devices, as per claim 2, wherein said first and second function devices are any from the group: microphone, speaker(s), keyboard, text display, video capture units, video display(s), pointing device(s), and coordinate device(s).

4. A computer-based system of building virtual network devices, as per claim 2, wherein said equivalent network device comprises a virtual telephone comprising four function devices.

5. A computer-based system of building virtual network devices, as per claim 3, wherein said four function devices comprise at least a microphone, speaker(s), keyboard and text display.

6. A computer-based system of building virtual network devices, as per claim 1, wherein said terminal server processes inputs/outputs comprising system control signaling and RTP data communications.

7. A computer-based system of building virtual network devices, as per claim 2, said two or more function devices comprise at least a microphone, speaker(s), keyboard and video display which are associated and registered to build a virtual laptop computer.

8. A computer-based system of building virtual network devices, as per claim 2, wherein said two or more function devices include a plurality of video capture devices which are associated and registered to build a virtual closed circuit security system.

9. A computer-based system of building virtual network devices, as per claim 2, wherein said two or more function devices include a plurality of video display devices which are associated and registered to build a virtual video on demand system.

10. A computer-based system of building virtual network devices, as per claim 2, wherein said terminal server creates any of a: H.323/SIP, H.248/Megaco or MGCP endpoint for said associated devices.

11. A computer-based system of building virtual network devices, as per claim 11, wherein said registration registers an alias address comprises any of a: H.323/SIP, H.248/Megaco or MGCP URL of said endpoint.

12. A computer-based system of building virtual network devices, as per claim 2, wherein said two or more function devices are contained within separate physical structures and are each registered under their own URL.

13. A computer-based system of building virtual network devices, as per claim 2, wherein said two or more function devices are contained within a single physical structure and are registered under a common URL.

14. A computer-based system of building virtual network devices, as per claim 2, wherein said two or more function devices are connected across wireless networks.

15. A computer based method of dynamically building virtual network devices, said devices comprising a plurality of input/output components operatively connected to one or more remote servers over an IP network, said method comprising:
at least one terminal server discovering functional devices connected to said network;
said at least one terminal server binding two or more of said input/output components;
said at least one terminal server registering said bound input/output components and associated communication protocols, and
said at least one terminal server emulating a virtual network device using representative functional applications located on said one or more servers in conjunction with said bound input/output components.

16. A computer based method of dynamically building virtual network devices, as per claim 15, wherein said method binds two or more input/output components.

17. A computer based method of dynamically building virtual network devices, as per claim 15, wherein said plurality of input/output components are any from the group:
microphone, speaker(s), keyboard, text display, video capture units, video display(s), pointing device(s), and coordinate device(s).

18. A computer based method of dynamically building virtual network devices, as per claim 15, wherein said virtual network device comprises a virtual telephone comprising four bound input/output components.

19. A computer based method of dynamically building virtual network devices, as per claim 18, wherein said four bound input/output components comprise at least a microphone, speaker(s), keyboard and text display.

20. A computer based method of dynamically building virtual network devices, as per claim 15, wherein said terminal server processes inputs/outputs comprising system control signaling and RTP data communications.

21. A computer based method of dynamically building virtual network devices, as per claim 15, wherein said virtual network device comprises a virtual laptop computer comprising a plurality of bound input/output components comprising at least a microphone, speaker(s), keyboard and video display.

22. A computer based method of dynamically building virtual network devices, as per claim 15, wherein said terminal server creates any of a: H.323/SIP, H.248/Megaco or MGCP endpoint for said bound devices.

23. A computer based method of dynamically building virtual network devices, as per claim 22, wherein said registration registers an alias address comprising any of a: H.323/SIP, H.248/Megaco or MGCP of said endpoint.

24. A computer based method of dynamically building virtual network devices, as per claim 15, wherein said plurality of bound input/output components are registered under separate IP addresses.

25. A computer based method of dynamically building virtual network devices, as per claim 15, wherein said plurality of bound input/output components are contained within a single physical structure and are registered under a common transport address.

26. A computer based method of dynamically building virtual network devices, as per claim 15, wherein said plurality of bound input/output components are contained within separate physical structures and are each registered under their own transport addresses.

27. A computer based method of dynamically building virtual network devices, as per claim 15, wherein said plurality of bound input/output components are connected across wireless networks.
